(19) United States
(12) Patent Application Publication
(10) Pub. No.: US 2025/0271678 A1
(43) Pub. Date: Aug. 28, 2025

(54) Augmented Reality Smart Glasses Device

(71) Applicant: Ashley Atwood, Vernal, UT (US)

(72) Inventor: Ashley Atwood, Vernal, UT (US)

(21) Appl. No.: 19/063,943

(22) Filed: Feb. 26, 2025

Related U.S. Application Data
(60) Provisional application No. 63/557,726, filed on Feb. 26, 2024.

(51) Int. Cl. G02B 27/01; G02C 3/00; G02C 11/00

(52) U.S. Cl. CPC G02B 27/0176; G02C 3/003; G02C 11/10; G02B 2027/0178

(57) ABSTRACT

A smart glasses device is disclosed which is a pair of augmented reality smart glasses designed for motorcyclists to enhance their riding experience. The smart glasses device comprises a glasses component that is configured in a conventional eyeglass or goggle configuration. The glasses component comprises a clear screen capable of displaying GPS coordinates, initiating calls, detecting radar signals, and providing directions, etc. The glasses component is also paired with a phone for navigation and calls. The glasses component comprises a USB charge port and supports both wireless and plug-in earbuds. Further, the glasses component comprises a removable head strap to secure the device to a user's head.

### CROSS-REFERENCE TO RELATED APPLICATION

The present application claims priority to, and the benefit of, U.S. Provisional Application No. 63/557,726, which was filed on Feb. 26, 2024, and is incorporated herein by reference in its entirety.

### FIELD OF THE INVENTION

The present invention relates generally to the field of smart glasses devices. More specifically, the present invention relates to a smart device that can be used while riding a motorcycle. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in smart glasses devices. Generally, many motorcyclists need to use or access their cell phone while riding. However, using a cell phone while riding can prove incredibly dangerous.

Further, it can be nearly impossible to manage a phone or other smart device while riding a motorcycle. Users typically need to pull over constantly to make phone calls and check directions. Thus, users need a device that allows hands-free calling and displays GPS coordinates and directions, while still being able to safely ride on a motorcycle.

Accordingly, there is a demand for an improved smart glasses device that has heads-up functionality and radar detection capabilities. More particularly, there is a demand for a smart glasses device that can be paired with a smartphone for navigation and calls.

Therefore, there exists a long-felt need in the art for a smart glasses device that provides users with an augmented reality smart glasses device that is designed for motorcyclists to enhance their riding experience. There is also a long-felt need in the art for a smart glasses device that provides advanced heads-up functionality and radar detection capabilities. Further, there is a long-felt need in the art for a smart glasses device that provides a hands-free solution that allows riders to navigate and make calls without the need to stop. Moreover, there is a long-felt need in the art for a device that includes a clear screen capable of displaying GPS coordinates, initiating calls, detecting radar signals, and providing turn-by-turn directions among other features. Further, there is a long-felt need in the art for a smart glasses device that can be paired with a phone for navigation and calls. Finally, there is a long-felt need in the art for a smart glasses device that includes a USB-C port and supports both wireless and plug-in earbuds.

The subject matter disclosed and claimed herein, in one embodiment thereof, comprises a smart glasses device. The device is a pair of augmented reality smart glasses designed for motorcyclists to enhance their riding experience. The smart glasses device comprises a glasses component that is configured in a conventional eyeglass or goggle configuration. The glasses component comprises a clear screen capable of displaying GPS coordinates, initiating calls, detecting radar signals, and providing directions, etc. The glasses component is also paired with a phone for navigation and calls. The glasses component comprises a USB charge port and supports both wireless and plug-in earbuds. Further, the glasses component comprises a removable head strap to secure the device to a user's head.

In this manner, the smart glasses device of the present invention accomplishes all of the forgoing objectives and provides users with a device that enhances a motorcyclist's riding experience. The device is augmented reality smart glasses designed to be paired with a smartphone. The device can comprise a USB port and earbuds.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart glasses device. The device is a pair of augmented reality smart glasses designed for motorcyclists to enhance their riding experience. The smart glasses device comprises a glasses component that is configured in a conventional eyeglass or goggle configuration. The glasses component comprises a clear screen capable of displaying GPS coordinates, initiating calls, detecting radar signals, and providing directions, etc. The glasses component is also paired with a cellular phone for navigation and calls. The glasses component comprises a USB charge port and supports both wireless and plug-in earbuds. Further, the glasses component comprises a removable head strap to secure the device to a user's head.

In one embodiment, the smart glasses device comprises a glasses component including various components, although other components may also be used. More or less components may alternatively be implemented. For example, the glasses component includes transparent glass, a processor/controller, a microphone, an audio output device, a touch sensor, a memory, and a wireless communication device, etc. The components included in the glasses component are described below. The glass of the glasses component is as transparent as general glasses, and the user wearing the glasses component may see through the glass.

In one embodiment, the glasses component is shown to enhance the augmented reality information described herein. The glasses component can have a front frame component with a bridge and end pieces, which are connected to arm components. Corrective lenses are then secured within the front frame component, or regular transparent lenses can be utilized, as is known in the art. The arm components include the microphone, battery, power button, bone conduction speakers, connectivity module and hardware, USB port, and cellular communications unit and hardware, which enables the glasses component to communicate over the cellular wireless network, AI interface, etc., all of which are electronically connected.

In one embodiment, the glasses component can be any suitable shape and size as is known in the art, depending on the size and shape of a user's head. Further, the glasses component can be configured as a conventional pair of glasses, such as goggles, safety goggles, motorcycle goggles, safety glasses, sport glasses, ballistic goggles, etc., depending on the needs and/or wants of a user.

In one embodiment, the glasses component comprises a processor/controller, battery, user interface, microphone, speakers, and smart device connectivity module and hardware, which may use WiFi, Bluetooth, near field communication, and/or other types of wireless technology standards to pair and/or communicate with other mobile devices, and cellular communications unit and hardware, which enables the glasses component to communicate over the cellular network. Other components of the glasses component can be included, such as an accelerometer, a GPS chip and a memory unit, etc.

In one embodiment, the connectivity module and hardware may use WiFi, Bluetooth, near field communication, and/or other types of wireless technology standards to pair and/or communicate with other mobile devices, including smartphones and smartwatches. Other components not depicted could also be included in the glasses component.

In one embodiment, the wireless communication device may include at least one module capable of wireless communication between the glasses component and a wireless communication system or smart device. For example, the wireless communication device may include a broadcast receiving module, a mobile communication module, a wireless Internet module, a local area communication module, a position information module, and the like. Other modules may be used for the wireless communication device.

In one embodiment, the glasses component includes a connection manager screen or user interface that can be used to accept input commands to pair and connect smart devices to the glasses component. The connection manager screen can be presented on the glasses component. Specifically, the screen depicts devices that can be connected to or paired with. The screen shows all the smart devices in range. Any suitable smart device can be paired or connected for use.

In one embodiment, the processor/controller controls operation of the glasses component. Namely, the processor/controller controls the components of the glasses component and their functioning and can provide radar detection, broadcast directions, and provide hands-free calls.

In one embodiment, the glasses component may serve as a transparent display for providing information. For example, the glasses component comprises a display for displaying GPS coordinates, providing turn-by-turn directions, or displaying calls. The display can be a conventional LCD or LED display and can include a touchpad or panel.

In one embodiment, the touch sensor may be configured to convert changes in a pressure or a capacitance applied by touching a predetermined area into an electrical input signal. The touch sensor may be configured to detect a touch pressure as well as a touched position or area. The touch sensor may be implemented as a proximity sensor. The proximity sensor has longer lifespan and more excellent utilization than a contact sensor. The date input through the touch sensor may be used to execute the specific function of the smart glass.

In one embodiment, the microphone may receive an external audio signal in a call mode, a recording mode, and/or a speech recognition mode and may convert the received audio signal into electric audio data. The microphone may employ various noise removal algorithms (or noise canceling algorithms) for removing or reducing a noise generated when the external audio signal is received. The audio output device may output audio data. The audio output device may include a receiver, a speaker, a buzzer, and/or the like. The audio output device may output sounds through a bone conduction speaker or an earphone jack. The user may hear the sounds by connecting an earphone/earbuds to the earphone jack or using wireless earbuds.

In one embodiment, the memory may store a program for an operation of the processor/controller and also may temporarily store input/output data (for example, phone numbers, a message, etc.). The memory may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk and/or an optical disk.

In one embodiment, a power supply device may receive external power and internal power and may provide power required for operations of the components of the glasses component under the control of the processor/controller. Typically, the power supply device is a rechargeable or replaceable battery. Further, the glasses component comprises a USB charge port for charging the batteries or other power supply components.

In one embodiment, various embodiments disclosed herein may be implemented within a recording medium that can be read by a computer or a computer-like device using software, hardware, or a combination thereof. According to the hardware implementation, embodiments may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. The embodiments may be implemented by the processor/controller. According to the software implementation, embodiments such as procedures or functions may be implemented with a separate software module that executes at least one function or operation. Software codes may be implemented according to a software application written in an appropriate software language. The software codes may be stored in the memory and executed by the processor/controller.

In one embodiment, the glasses component comprises a removable head strap. The head strap is flexible and typically made of an elastic material to conform to the head of the user. The removable head strap has opposing ends with spring clips which removably secure the strap to the glasses component, allowing the device to stay securely in place while riding along a road on a motorcycle. A user can also remove the head strap and position removable arm ends on each arm of the glasses component. The removable arm ends would also comprise springs clips or other securing means as is known in the art.

In yet another embodiment, the smart glasses device comprises a plurality of indicia.

In yet another embodiment, a method of enhancing a motorcyclist's riding experience with augmented reality glasses is disclosed. The method includes the steps of providing a smart glasses device comprising a glasses component with a clear screen. The method also comprises pairing a phone with the glasses component. Further, the method comprises displaying GPS coordinates, initiating calls, detecting radar signals, and providing directions via the glasses component. The method also comprises utilizing wireless and plug-in earbuds with the glasses component. Finally, the method comprises securing the glasses component to a user's head for use via the head strap.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-D illustrate a perspective view of one embodiment of the smart glasses device of the present invention showing the device and its components in accordance with the disclosed architecture;

FIGS. 2A-B illustrate a perspective view of one embodiment of the smart glasses device of the present invention showing how the removable head strap can be secured in accordance with the disclosed architecture;

FIGS. 3A-B illustrate a perspective view of one embodiment of the smart glasses device of the present invention showing the device applied to a user's head in accordance with the disclosed architecture;

FIGS. 4A-E illustrate a perspective view of one embodiment of the smart glasses device of the present invention showing how the earbuds are utilized in accordance with the disclosed architecture;

FIGS. 5A-C illustrate a perspective view of one embodiment of the smart glasses device of the present invention showing the device in use in accordance with the disclosed architecture; and

FIG. 6 illustrates a flowchart showing the method of enhancing a motorcyclist's riding experience with augmented reality glasses in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a smart glasses device that provides users with an augmented reality smart glasses device that is designed for motorcyclists to enhance their riding experience. There is also a long-felt need in the art for a smart glasses device that provides advanced heads-up functionality and radar detection capabilities. Further, there is a long-felt need in the art for a smart glasses device that provides a hands-free solution that allows riders to navigate and make calls without the need to stop. Moreover, there is a long-felt need in the art for a device that includes a clear screen capable of displaying GPS coordinates, initiating calls, detecting radar signals, and providing turn-by-turn directions among other features. Further, there is a long-felt need in the art for a smart glasses device that can be paired with a phone for navigation and calls. Finally, there is a long-felt need in the art for a smart glasses device that includes a USB-C port and supports both wireless and plug-in earbuds.

The present invention, in one exemplary embodiment, is a novel smart glasses device. The smart glasses device comprises a glasses component that is configured in a conventional eyeglass or goggle configuration. The glasses component comprises a clear screen capable of displaying GPS coordinates, initiating calls, detecting radar signals, and providing directions, etc. The glasses component is also paired with a phone for navigation and calls. The glasses component comprises a USB charge port and supports both wireless and plug-in earbuds. Further, the glasses component comprises a removable head strap to secure the device to a user's head. The present invention also includes a novel method of enhancing a motorcyclist's riding experience with augmented reality glasses. The method includes the steps of providing a smart glasses device comprising a glasses component with a clear screen. The method also comprises pairing a phone with the glasses component. Further, the method comprises displaying GPS coordinates, initiating calls, detecting radar signals, and providing directions via the glasses component. The method also comprises utilizing wireless and plug-in earbuds with the glasses component. Finally, the method comprises securing the glasses component to a user's head for use via the head strap.

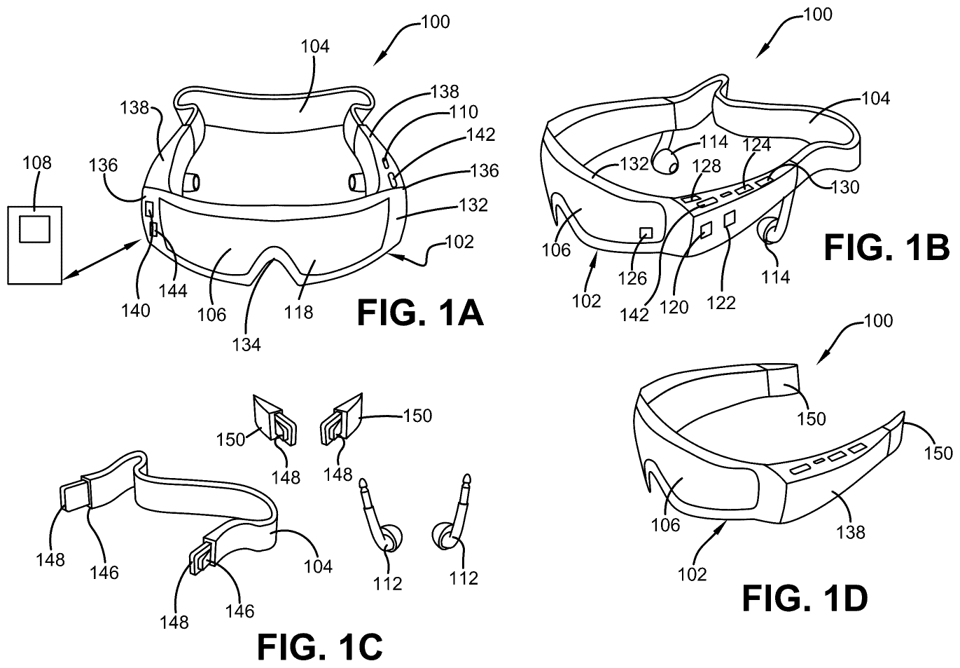

Referring initially to the drawings, FIGS. 1A-D illustrate a perspective view of one embodiment of the smart glasses device 100 of the present invention. In the present embodiment, the smart glasses device 100 is an improved smart glasses device 100 that provides a user 106 with augmented reality smart glasses designed for motorcyclists to enhance their riding experience. Specifically, the smart glasses device 100 comprises a glasses component 102 and a head strap 104. The glasses component 102 comprises a clear screen 106 capable of displaying GPS coordinates, initiating calls, detecting radar signals, and providing directions, etc. The glasses component 102 is also paired with a cellular phone 108 for navigation and calls. The glasses component 102 comprises a USB charge port 110 and supports both wireless 112 and plug-in 114 earbuds. Further, the glasses component 102 comprises a removable head strap 104 to secure the device to a user's head 116.

Generally, the smart glasses device 100 comprises a glasses component 102 including various components, although other components may also be used. More or less components may alternatively be implemented. For example, the glasses component 102 includes transparent glass 118, a processor/controller 120, a microphone 122, an audio output device/speaker 124, a touch sensor 126, a memory 128, and a wireless communication device 130, etc. The components included in the glasses component 102 are described below. The glass 118 of the glasses component 102 is as transparent as general glasses, and the user wearing the glasses component 102 may see through the glass 118.

Further, the glasses component 102 is shown to enhance the augmented reality information described herein. The glasses component 102 can have a front frame component 132 with a bridge 134 and end pieces 136, which are connected to arm components 138. Corrective lenses 118 are then secured within the front frame component 132, or regular transparent lenses 118 can be utilized, as is known in the art. The arm components 138 include the microphone 122, battery 140, power button 142, bone conduction speakers 124, connectivity module and hardware, USB port 110, and cellular communications unit and hardware (i.e., wireless communication device 130), which enables the glasses component 102 to communicate over the cellular wireless network, AI interface, etc., all of which are electronically connected.

Additionally, the glasses component 102 can be any suitable shape and size as is known in the art, depending on the size and shape of a user's head 116. Further, the glasses component 102 can be configured as a conventional pair of glasses, such as goggles, safety goggles, motorcycle goggles, safety glasses, sport glasses, ballistic goggles, etc., depending on the needs and/or wants of a user.

In one embodiment, the glasses component 102 comprises a processor/controller 120, battery 140, user interface 144, microphone 122, speakers 124, and smart device connectivity module 130 and hardware, which may use WiFi, Bluetooth, near field communication, and/or other types of wireless technology standards to pair and/or communicate with other mobile devices 108, and cellular communications unit and hardware, which enables the glasses component 102 to communicate over the cellular network. Other components of the glasses component 102 can be included, such as an accelerometer, a GPS chip, and a memory unit 128, etc.

Further, the connectivity module 130 and hardware may use WiFi, Bluetooth, near field communication, and/or other types of wireless technology standards to pair and/or communicate with other mobile devices 108, including smartphones and smartwatches. Other components not depicted could also be included in the glasses component 102.

Additionally, the wireless communication device 130 may include at least one module capable of wireless communication between the glasses component 102 and a wireless communication system 130 or smart device 108. For example, the wireless communication device 130 may include a broadcast receiving module, a mobile communication module, a wireless Internet module, a local area communication module, a position information module, and the like. Other modules may be used for the wireless communication device 130.

Furthermore, the glasses component 102 includes a connection manager screen or user interface 144 that can be used to accept input commands to pair and connect smart devices 108 to the glasses component 102. The connection manager screen 144 can be presented on the glasses component 102. Specifically, the screen 144 depicts devices 108 that can be connected to or paired with. The screen 144 shows all the smart devices 108 in range. Any suitable smart device 108 can be paired or connected for use.

Further, the glasses component 102 may serve as a transparent display 106 for providing information. For example, the glasses component 102 comprises a display 106 for displaying GPS coordinates, providing turn-by-turn directions, or displaying calls. The display 106 can be a conventional LCD or LED display and can include a touchpad/touch sensor or panel 126.

Additionally, the glasses component 102 comprises a removable head strap 104. The head strap 104 is flexible and typically made of an elastic material to conform to the head 116 of the user. The removable head strap 104 has opposing ends 146 with spring clips 148 which removably secure the strap 104 to the glasses component 102, allowing the device 100 to stay securely in place while riding along a road on a motorcycle. A user can also remove the head strap 104 and position removable arm ends 150 on each arm component 138 of the glasses component 102. The removable arm ends 150 would also comprise spring clips 148 or other securing means as is known in the art.

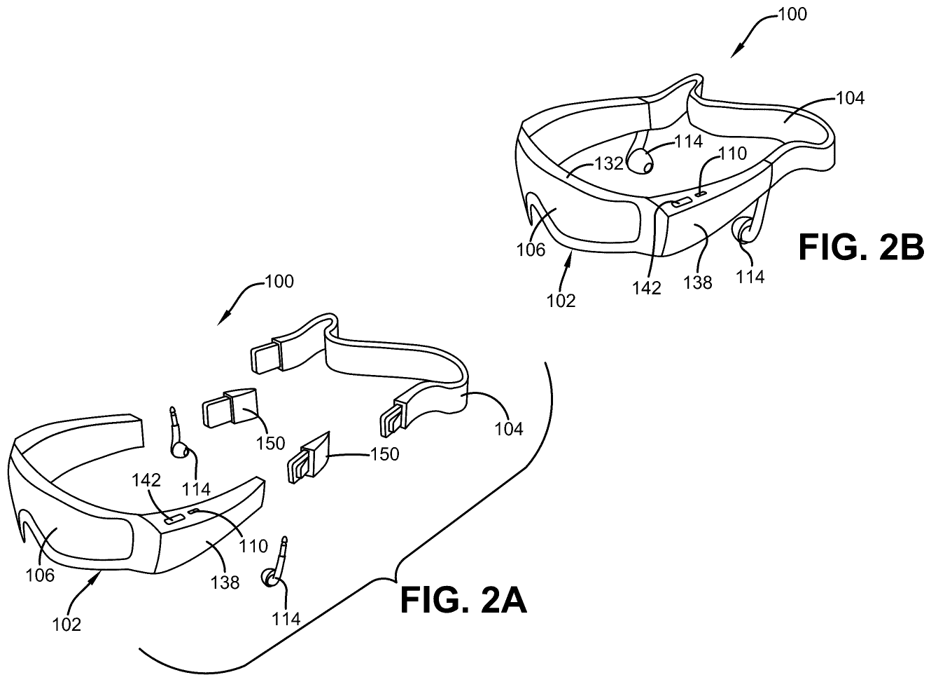

As shown in FIGS. 2A-B, the microphone 122 may receive an external audio signal in a call mode, a recording mode, and/or a speech recognition mode and may convert the received audio signal into electric audio data. The microphone 122 may employ various noise removal algorithms (or noise canceling algorithms) for removing or reducing a noise generated when the external audio signal is received. The audio output device/speaker 124 may output audio data. The audio output device 124 may include a receiver, a speaker, a buzzer, and/or the like. The audio output device 124 may output sounds through a bone conduction speaker or an earphone jack 200. The user may hear the sounds by connecting an earphone/earbuds 114 to the earphone jack 200 or using wireless earbuds 112.

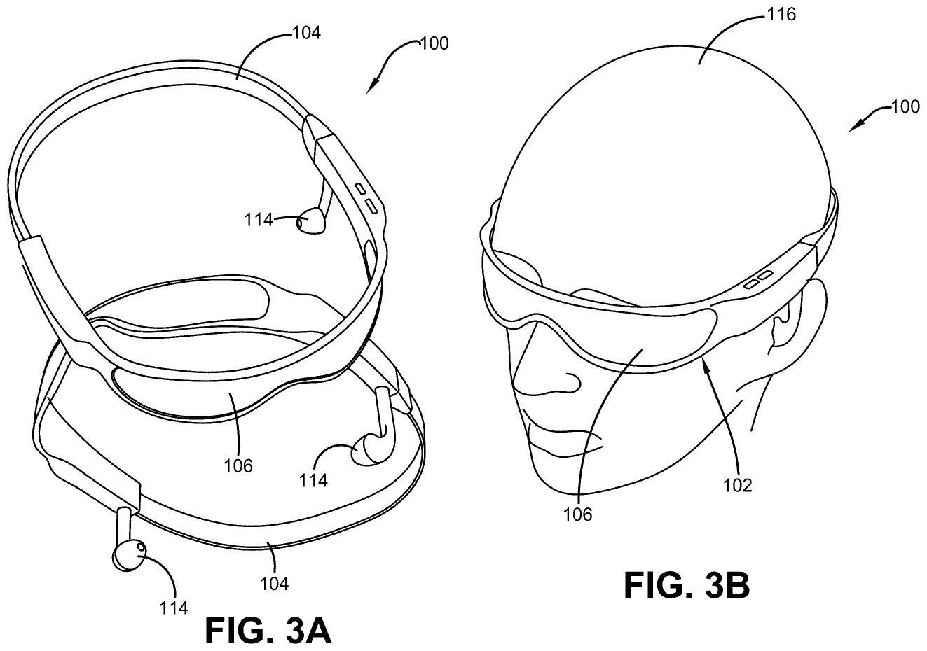

As shown in FIGS. 3A-B, the processor/controller 120 controls operation of the glasses component 102. Namely, the processor/controller 120 controls the components of the glasses component 102 and their functioning and can provide radar detection, broadcast directions, and provide hands-free calls.

Further, the touch sensor 126 may be configured to convert changes in a pressure or a capacitance applied by touching a predetermined area into an electrical input signal. The touch sensor 126 may be configured to detect a touch pressure as well as a touched position or area. The touch sensor 126 may be implemented as a proximity sensor. The proximity sensor has a longer lifespan and more excellent utilization than a contact sensor. The date input through the touch sensor 126 may be used to execute the specific function of the smart glass device 100.

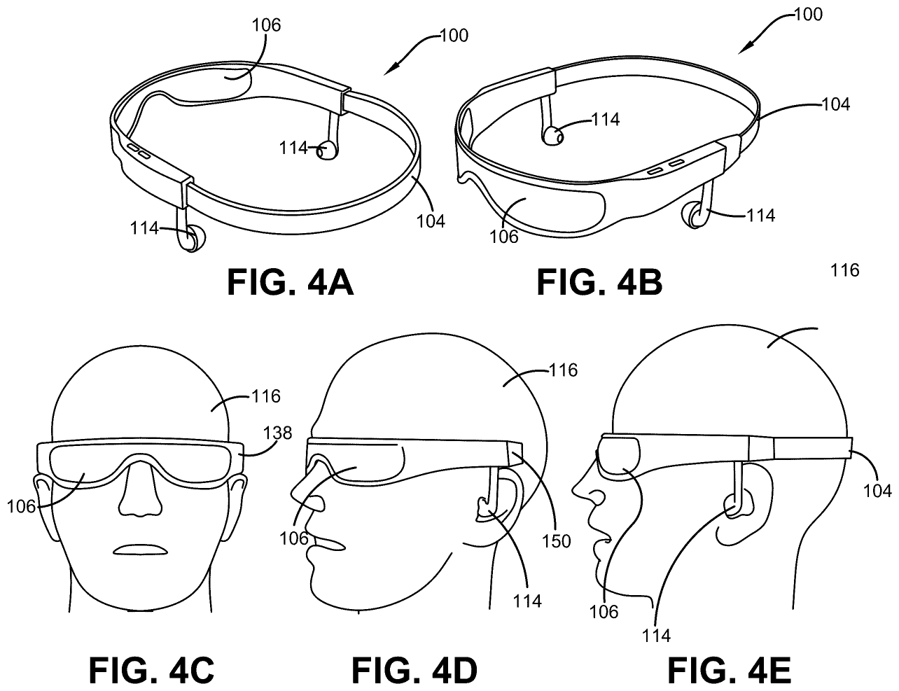

As shown in FIGS. 4A-E, the memory 128 may store a program for an operation of the processor/controller 120 and also may temporarily store input/output data (for example, phone numbers, a message, etc.). The memory 128 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk and/or an optical disk.

Further, a power supply device 140 may receive external power and internal power and may provide power required for operations of the components of the glasses component 102 under the control of the processor/controller 120. Typically, the power supply device 140 is a rechargeable or replaceable battery 140. Further, the glasses component 102 comprises a USB charge port 110 for charging the batteries 140 or other power supply components.

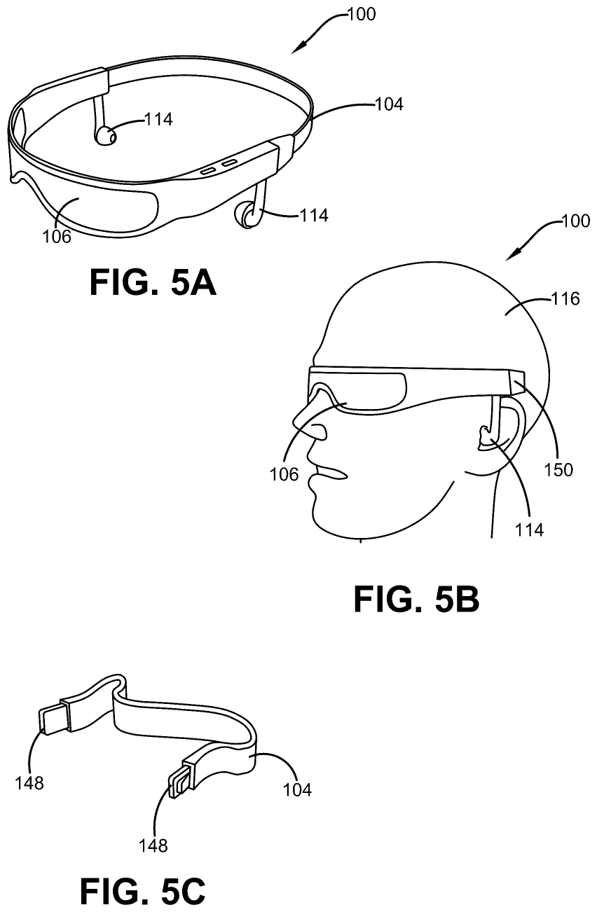

As shown in FIGS. 5A-C, various embodiments disclosed herein may be implemented within a recording medium that can be read by a computer or a computer-like device using software, hardware, or a combination thereof. According to the hardware implementation, embodiments may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. The embodiments may be implemented by the processor/controller 120. According to the software implementation, embodiments such as procedures or functions may be implemented with a separate software module that executes at least one function or operation. Software codes may be implemented according to a software application written in an appropriate software language. The software codes may be stored in the memory 128 and executed by the processor/controller 120.

In yet another embodiment, the smart glasses device 100 comprises a plurality of indicia 500. The glasses component 102 of the device 100 may include advertising, a trademark, or other letters, designs, or characters, printed, painted, stamped, or integrated into the glasses component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be glasses, goggles, or brand related.

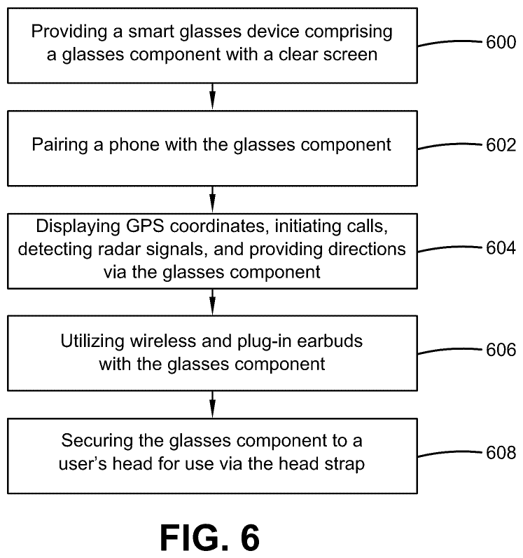

FIG. 6 illustrates a flowchart of the method of enhancing a motorcyclist's riding experience with augmented reality glasses. The method includes the steps of at 600, providing a smart glasses device comprising a glasses component with a clear screen. The method also comprises at 602, pairing a phone with the glasses component. Further, the method comprises at 604, displaying GPS coordinates, initiating calls, detecting radar signals, and providing directions via the glasses component. The method also comprises at 606, utilizing wireless and plug-in earbuds with the glasses component. Finally, the method comprises at 608, securing the glasses component to a user's head for use via the head strap.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “smart glasses device”, “smart device”, “glasses device”, and “device” are interchangeable and refer to the smart glasses device 100 of the present invention.

Notwithstanding the foregoing, the smart glasses device 100 of the present invention can be of any suitable size and configuration as is known in the art without affecting the overall concept of the invention, provided that it accomplishes the above-stated objectives. One of ordinary skill in the art will appreciate that the smart glasses device 100 as shown in FIGS. 1-6 is for illustrative purposes only, and that many other sizes and shapes of the smart glasses device 100 are well within the scope of the present disclosure. Although the dimensions of the smart glasses device 100 are important design parameters for user convenience, the smart glasses device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart glasses device that provides a user with augmented reality smart glasses designed for motorcyclists, the smart glasses device comprising:
a glasses component; and
a clear screen;
wherein the clear screen is capable of displaying GPS coordinates, initiating calls, detecting radar signals, and providing directions; and
further wherein the glasses component is paired with a cellular phone for navigation and calls.

2. The smart glasses device of claim 1, wherein the glasses component has a front frame component with a bridge and end pieces, which are connected to arm components.

3. The smart glasses device of claim 2, wherein corrective lenses or regular transparent lenses are then secured within the front frame component.

4. The smart glasses device of claim 3, wherein the arm components include a microphone, a battery, a power button, bone conduction speakers, a USB port, and wireless communication device.

5. The smart glasses device of claim 4, wherein the wireless communication device includes at least one module capable of wireless communication between the glasses component and a wireless communication system or smart device.

6. The smart glasses device of claim 5, wherein the glasses component includes a user interface that can be used to accept input commands to pair and connect smart devices to the glasses component.

7. The smart glasses device of claim 6, wherein the user interface can be presented on the glasses component, such that the clear screen depicts smart devices that can be connected to or paired with.

8. The smart glasses device of claim 7, wherein the glasses component comprises a removable head strap, which has opposing ends with spring clips which removably secure the removable head strap to the glasses component.

9. The smart glasses device of claim 8, wherein the removable head strap can be removed and removable arm ends with spring clips can be attached to the arm components for use.

10. The smart glasses device of claim 9, wherein the microphone and bone conduction speakers allow users to send and receive external audio signals via the paired smart device.

11. The smart glasses device of claim 10, wherein sounds are output from the external audio signals via an earphone jack and connected earbuds or wireless earbuds.

12. The smart glasses device of claim 11, wherein glasses component comprises a touch sensor to control functioning of the glasses component.

13. The smart glasses device of claim 12, wherein a rechargeable or replaceable battery is used to charge the glasses component.

14. The smart glasses device of claim 13, wherein the USB charge port is positioned to charge the battery.

15. A smart glasses device that provides a user with augmented reality smart glasses designed for motorcyclists, the smart glasses device comprising:
a glasses component comprising a front frame component with a bridge and end pieces, which are connected to arm components; and
a clear screen;
wherein corrective lenses or regular transparent lenses are then secured within the front frame component;
wherein the arm components include a microphone, a battery, a power button, bone conduction speakers, a USB port, and wireless communication device;
wherein the clear screen is capable of displaying GPS coordinates, initiating calls, detecting radar signals, and providing directions;
wherein the glasses component is paired with a cellular phone for navigation and calls;
wherein the wireless communication device includes at least one module capable of wireless communication between the glasses component and a wireless communication system or smart device;
wherein the glasses component includes a user interface that can be used to accept input commands to pair and connect smart devices to the glasses component; and
further wherein the user interface can be presented on the glasses component, such that the clear screen depicts smart devices that can be connected to or paired with.

16. The smart glasses device of claim 15, wherein the glasses component comprises a removable head strap, which has opposing ends with spring clips which removably secure the removable head strap to the glasses component.

17. The smart glasses device of claim 16, wherein the removable head strap can be removed and removable arm ends with spring clips can be attached to the arm components for use.

18. The smart glasses device of claim 15, wherein sounds are output from external audio signals via an earphone jack and connected earbuds or wireless earbuds.

19. The smart glasses device of claim 15 further comprising a plurality of indicia.

20. A method of enhancing a motorcyclist's riding experience with augmented reality glasses, the method comprising the following steps:
providing a smart glasses device comprising a glasses component with a clear screen;
pairing a phone with the glasses component;
displaying GPS coordinates, initiating calls, detecting radar signals, and providing directions via the glasses component;
utilizing wireless and plug-in earbuds with the glasses component; and
securing the glasses component to a user's head for use via the head strap.
